(19) United States
(12) Patent Application Publication
(10) Pub. No.: US 2026/0206724 A1
(43) Pub. Date: Jul. 23, 2026

(54) ASSISTANCE AND/OR PROTECTIVE VEST AND UNDER LAYER THEREFOR

(71) Applicant: Michele Carter, Cincinnati, OH (US)

(72) Inventor: Michele Carter, Cincinnati, OH (US)

(21) Appl. No.: 19/033,884

(22) Filed: Jan. 22, 2025

(51) Int. Cl. A01K 27/00; A01K 13/00; A41D 1/04; A41D 13/05; B32B 3/12; B32B 5/02; B32B 25/10

(52) U.S. Cl. CPC A01K 27/002; A01K 13/006; B32B 3/12; B32B 5/02; B32B 25/10; A41D 1/04; A41D 13/0518; B32B 2307/546; B32B 2307/7375; B32B 2437/00

(57) ABSTRACT

A vest includes an external layer of fabric material and an under layer having open geometric structure comprising a repeating pattern of cells that are joined together in a continuous lattice-like network. The unit open geometric structure is characterized by interconnectedness and incorporates one of joints, hinges, and expandable patterns to allow movement.

### FIELD OF THE INVENTION

This invention relates generally to vests, and more particularly, but not by way of limitation, to an animal harness or protective vest with increased functionality, and more particularly, to a canine vest that can be worn comfortably and without causing under stress on the animal.

### BACKGROUND OF THE INVENTION

In certain circumstances, vests are required to be worn. This can be in the case of providing assistance or in potentially hostile environment. The vest is typically a versatile garment utilized by individuals and animals alike for a range of practical, cultural, and safety reasons. Originating as a functional piece of clothing, vests have evolved to serve various purposes in different contexts.

### Animal Applications

Animals, particularly service or working animals, often wear vests tailored to their roles:
Identification: Service animals, such as guide dogs or therapy animals, wear vests to signify their purpose and distinguish them from pets. This helps inform the public that the animal is performing a specific job.
Safety: Dogs, horses, and other animals may wear reflective vests for visibility during outdoor activities like hiking or nighttime walks. Protective vests are also worn, such as those made with Kevlar, and can shield against environmental hazards or attacks by other animals or attacks from fire arms.
Training and Work: Working animals in fields like search-and-rescue, fire department work, police work, or hunting might wear vests equipped with GPS trackers, harnesses, or storage for essential tools.

### Human Applications

For humans, vests are often worn for professional, functional and aesthetic use: Workers in construction, public safety, or transportation commonly wear reflective or high-visibility vests to ensure safety in hazardous environments. Tactical vests, used by military personnel and law enforcement, provide accessible storage for essential tools and protective gear.

Fashion and Cultural Expression: In fashion, vests are a staple in formalwear, adding sophistication to suits or tuxedos. In casual or outdoor settings, insulated vests provide warmth without restricting mobility, making them popular among hikers and sports enthusiasts.

Medical or Support Needs: Weighted vests are often used in therapy to provide sensory input for individuals with autism or sensory processing disorders. Compression vests can help alleviate anxiety by offering a calming effect.

### Symbolic and Functional Importance

Vests represent a blend of practicality and symbolism, indicating roles, enhancing safety, or offering comfort. For humans and animals, the vest remains an indispensable garment, adaptable to the needs of various roles and professions.

While the use and need for vests including, but limited those applications identified above exists, there remains a need to improve vests in order to render them more user friendly to the wearer. Accordingly, the instant invention aims to improve the deficiencies in the art.

### SUMMARY OF THE INVENTION

It is an object to improve vests.

It is another to render vests more functional.

Another object is to provide an under layer to a vest which renders the vest more breathable and comfortable.

Still another object is to reduce increase air circulation between the vest and the wearer thus reducing fatigue.

Accordingly, an aspect of the invention is directed to an under layer for a vest, which includes a multi-unit open geometric structure for disposal between a vest and a wearer. The multi-unit open geometric structure can include a honeycomb structure, for example, but is not limited thereto.

The structure can be interconnected and preferably flexible in that the overall structure refers to a geometric configuration comprising a repeating pattern of cells, typically hexagonal, that are joined together in a continuous, lattice-like network. This type of structure is characterized by interconnectedness.

Each cell in the structure shares its walls or edges with adjacent cells, forming a cohesive and unified network. The interconnected nature enhances the overall stability and strength of the structure, distributing loads and stresses evenly.

When mated against an external layer of material of the vest, the combination allows for adaptability to external forces, such as bending, stretching, or compression, without compromising the integrity of the structure. Flexibility can be achieved through elastic materials: For example, use of materials that can deform and recover, such as rubber or certain polymers or thermoplastic rubber are possible.

Geometric design is provided which incorporates joints, hinges, or expandable patterns in the honeycomb structure to allow movement. An interconnected and flexible honeycomb structure enables a lightweight and impact-absorbing material for energy dissipation. Such design provides high strength-to-weight ratio. It is contemplated the material may be stretchable and breathable. In addition, the design is effective at dissipating energy under impact or stress. Finally, the invention enables adaptability and can conform to complex shapes or respond dynamically to changes in load or environment.

Other features of the invention are apparent from the appended claims with reference to the description and the drawings.

### BRIEF DESCRIPTION OF THE DRAWINGS

FIG. 1 depicts a perspective of a vest of the invention in use on a dog.

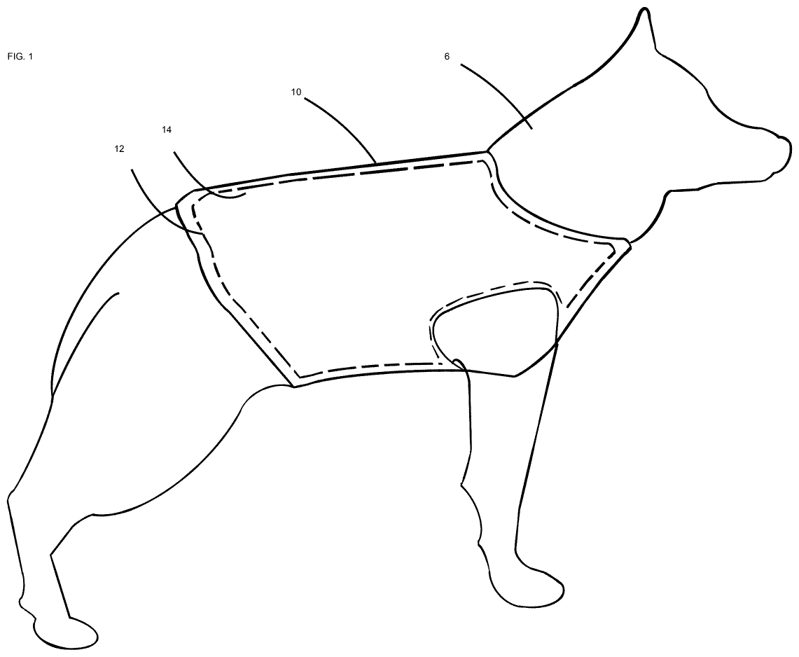

FIG. 2 shows the invention revealing an under layer of the vest of the invention in FIG. 1.

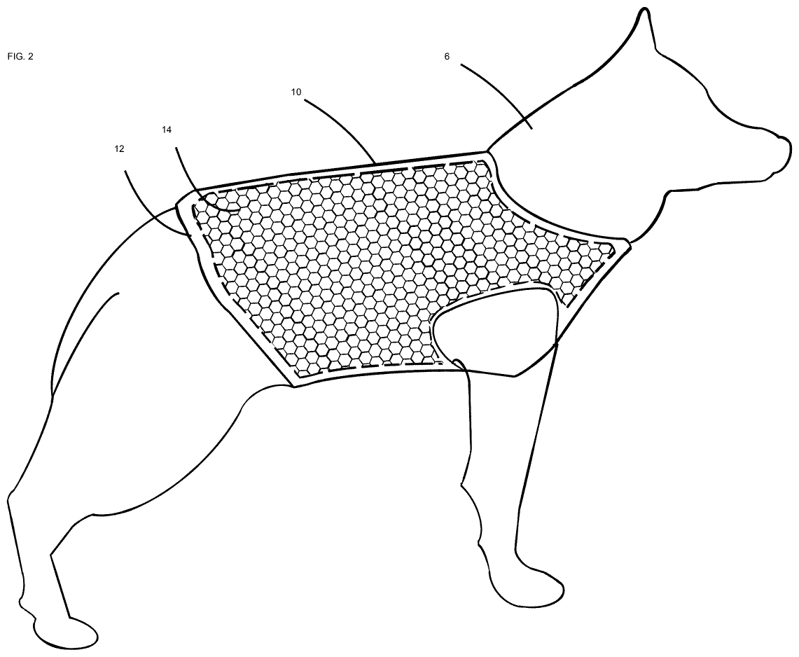

FIG. 3 depicts a perspective view of a section of the under layer of the invention.

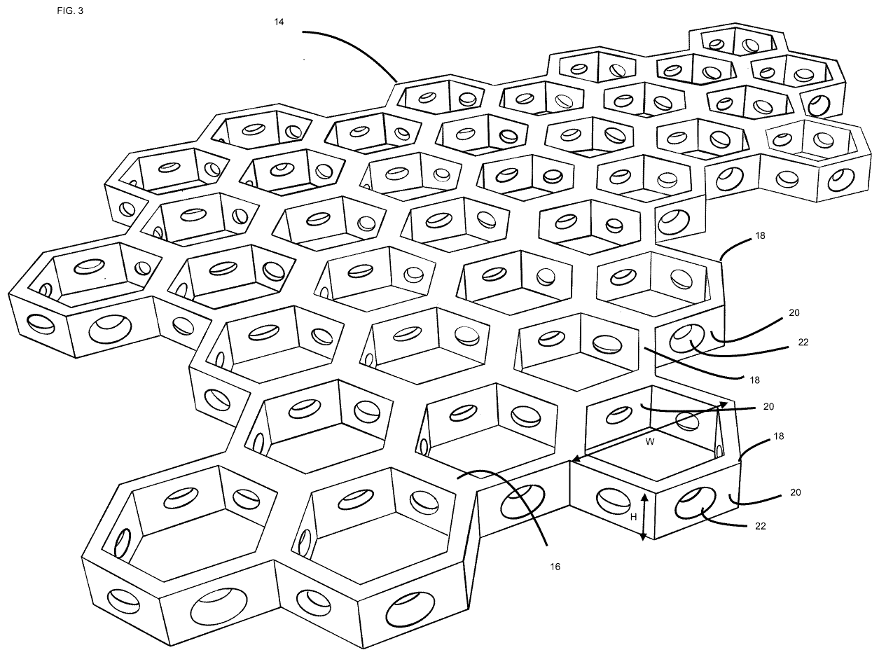

### DETAILED DESCRIPTION OF PREFERRED EMBODIMENT

Referring now to the drawings, a vest in connection with the invention is generally designation with the numeral 10. The vest 10 includes an external layer 12 and an under layer 14.

The external layer 12 can include a material or structure of those known in the art. For example, the external layer 12 can include a reflective material for visibility during outdoor activities like hiking or nighttime walks. Optionally, the external layer 12 can include protective material, such as Kevlar, to shield against environmental hazards or attacks. The external layer 12 can be equipped with GPS trackers, harnesses, or storage for essential tools.

In the case of humans, the external layer 12 can include accessible storage for essential tools and protective gear. Optionally, the external layer 12 can provide a non-formal or formalwear aspect. In addition, external layer 12 can be insulated to provide warmth without restricting mobility for active wearers. Further, external layer 12 can be equipped with weights for therapy or to provide sensory input for individuals with autism or sensory processing disorders. Compression vests 10 can help alleviate anxiety by offering a calming effect.

The under layer 14 can preferably include a multi-unit open geometric structure 16 for disposal between external layer 12 and a wearer 6. The multi-unit open geometric structure 16 can include a honeycomb structure, for example, but is not limited thereto. The unit open geometric structure 16 can, for example, have a cell unit size with height of at least about 4 to 8 mm and a width of about 12 mm.

The unit open geometric structure 16 can be interconnected and preferably flexible in that the overall structure refers to a geometric configuration comprising a repeating pattern of cells 18, for example, hexagonal, that are joined together in a continuous, lattice-like network. The height H of each cell can be, for example, about 4 to 8 mm and width of about 12 mm and include a plurality of side walls 20 each having an opening 22. This type of unit open geometric structure 16 is characterized by interconnectedness. In this way, the unit open geometric structure 16 provides a spaced relation between the wearer 6 and the external layer 12. The unit open geometric structure 16 provides air flow throughout.

Each cell 18 in the unit open geometric structure 16 shares its walls or edges with adjacent cells 18, forming an open yet cohesive and unified network. The interconnected nature enhances the overall stability and strength of the unit open geometric structure 16, distributing loads and stresses evenly.

When mated against an external layer 12 of material of the vest 10, the combination allows for adaptability to external forces, such as bending, stretching, or compression, without compromising the integrity of the structure. Flexibility can be achieved through elastic materials: For example, use of materials that can deform and recover, such as rubber or certain polymers or thermoplastic rubber are possible.

The unit open geometric structure 16 is provided which incorporates joints, hinges, or expandable patterns in the honeycomb structure to allow movement. Interconnected and flexible honeycomb structures enable a lightweight and impact-absorbing materials for energy dissipation. Such unit open geometric structure 16 provides high strength-to-weight ratio. It is contemplated the under layer 14 may be stretchable and breathable. In addition, the unit open geometric structure 16 is effective at dissipating energy under impact or stress. Finally, the invention enables adaptability and can conform to complex shapes or respond dynamically to changes in load or environment.

It will be understood that the embodiment of the present invention that the embodiment illustrated is merely exemplary and that a person skilled in the art can make variations to the shown embodiment without departing from the intended scope of the invention. All such variations, modifications and alternate embodiments are intended to be included within the scope of the present invention as defined by the claims.

1. A vest, which includes:
an external layer of fabric material; and
an under layer having an open geometric unitary structure formed of a repeating pattern of interconnected cells arranged in a continuous lattice-like network.

2. The vest of claim 1, wherein said interconnected cells share common sidewalls, thereby forming said open geometric unitary structure that distributes loads and permits airflow.

3. The vest of claim 2, wherein said unit open geometric unitary structure incorporates one of joints, hinges, and expandable patterns to allow movement.

4. The vest of claim 1, wherein said open geometric unitary structure incorporates a honeycomb structure.

5. The vest of claim 1, wherein said cells have a wall height of are about 4 mm to 8 mm in height.

6. The vest of claim 1, wherein said cells have a lateral span (width) of about 12 mm in width.

7. The vest of claim 1, wherein said unit open geometric unitary structure includes one of natural rubber and synthetic material.

8. The vest of claim 1, wherein said unit open geometric unitary structure includes thermoplastic rubber.

9. The vest of claim 1, wherein each of said cells has a plurality of side walls and at least one through-opening in each sidewall, the openings enabling ventilation and enhanced impact absorption.
